(19) United States
(12) Patent Application Publication
(10) Pub. No.: US 2005/0101705 A1
(43) Pub. Date: May 12, 2005

(54) Coating sheath for driving cables of power window devices for motor vehicles

(76) Inventor: Melchor Daumal Castellon, Barcelona (ES)

Correspondence Address: BLANK ROME LLP, 600 NEW HAMPSHIRE AVENUE, N.W., WASHINGTON, DC, 20037, US

(21) Appl. No.: 10/978,355

(22) Filed: Nov. 2, 2004

(30) Foreign Application Priority Data
Nov. 6, 2003 (ES) U200302548

(51) Int. Cl. C08K 5/15; C08J 3/00; C08L 1/00; C09D 5/18; C09D 5/16

(52) U.S. Cl. 524/112; 524/467; 106/18.23

(57) ABSTRACT

A sheath with a coating structure enclosing a driving cable that is formed of a single layer of a semirigid plastic material with a low thermal expansion and has an outer diameter ranging from 5 to 7 mm, preferably 6 mm, and an inner diameter ranging from 2.5 to 4 mm, preferably 3 mm. The sheath has simplified structure which, in conjunction with the predetermined dimensions, provides a more effective operation a substantially increased working life of the driving cable.

### RELATED APPLICATION

This application claims priority to Spanish Patent Application No. U200302548 filed Nov. 6, 2003.

### FIELD OF THE INVENTION

The present invention relates to a sheath for driving cables in power window devices for motor vehicles.

### BACKGROUND OF THE INVENTION

Conventional driving cables for power window devices of motor vehicles are typically provided with a sheath. The sheath is a coating structure that surrounds the cable. The coating structure typically includes a first layer made of a plastic material, an intermediate metal layer having an outward coiled strip surrounding the first layer, and a third outer plastic shielding layer surrounding the intermediate layer. Such configuration of the coating structure of the driving cable in power window devices is expensive. It also has further disadvantages with respect to the operation of the power window device, such as excess noise, friction, and the like, thereby reducing the working life of the driving cable. Excessive wear of the first or inner layer may result in direct contact of the metallic intermediate layer with the driving cable. This metal-to-metal contact inhibits proper operation of the power window device and often results in damage to the driving cable. The provision of the intermediate layer often promotes oxidation of the driving cable of the power window device.

### SUMMARY OF THE INVENTION

Accordingly, an object of the present invention is to provide a sheath for a driving cable of a power window device of motor vehicles with a simplified coating structure which, in conjunction with calculated dimensions, provide a more effective operation with regard to conventional driving cable sheaths in power window devices, thereby providing a substantially increased working life of the cable.

The foregoing object is basically attained by a coating structure formed of a single layer made of a semirigid plastic material. A plastic of a low thermal expansion is preferred, such as polyoxymethylene (POM) due to its good slip coefficient, excellent mechanical properties, its resistance to chemical agents (solvents, grease) and especially due to its degree of elasticity to conform to the driving cable path.

Preferably, said sheath coating structure has an inner diameter ranging from 2.5 to 4 mm and an outer diameter ranging from 5 to 7 mm. The preferred dimensions are: 3 mm inner diameter and 6 mm outer diameter. Dimensions exceeding the above dimension ranges could prevent the sheath from flexing to conform to the driving cable path; while dimensions below the ranges could result in a less resistant coating. Thus, it is preferable to keep at least the outer diameter parameters within the above ranges.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

The features and the advantages of the sheath or driving cables in power window devices for motor vehicles of the present invention will be clearer from the detailed description of a preferred embodiment thereof which will be given hereinafter by way of non-limitative example, with reference to the accompanying drawings, in which:

FIG. 1 is a partial elevational view in section of a sheath for driving cables in a power window device for motor vehicles according to prior art;

FIG. 2 is an elevational view in section of the sheath illustrated in FIG. 1;

FIG. 3 is a partial elevational view in section of a sheath for driving cables in a power window device for motor vehicles according to an embodiment to the present invention;

FIG. 4 is an elevational view of the sheath in FIG. 3; and

FIG. 5 is an elevational view in section of a power window device of a motor vehicle provided with the sheath as illustrated in FIGS. 3 and 4 according to an embodiment of the invention.

Reference numerals used to define the different parts in the embodiments of the invention are as follows:
(10) power window device;
(20) rail of the power window device;
(30) parallelism lower length;
(40a) rising length;
(40b) lowering length;
(50) pulley;
(60) slider;
(70) electric motor;
(100) conventional sheath;
(110) driving cable of a motor vehicle power window device;
(120) first inner layer;
(130) second, intermediate metal layer;
(140) third, outer plastic layer;
(200) sheath of the invention;
(210) coating layer of the sheath (200);
(d1) outer diameter of the sheath of the invention; and
(d2) inner diameter of the sheath of the invention.

### DETAILED DESCRIPTION OF THE INVENTION

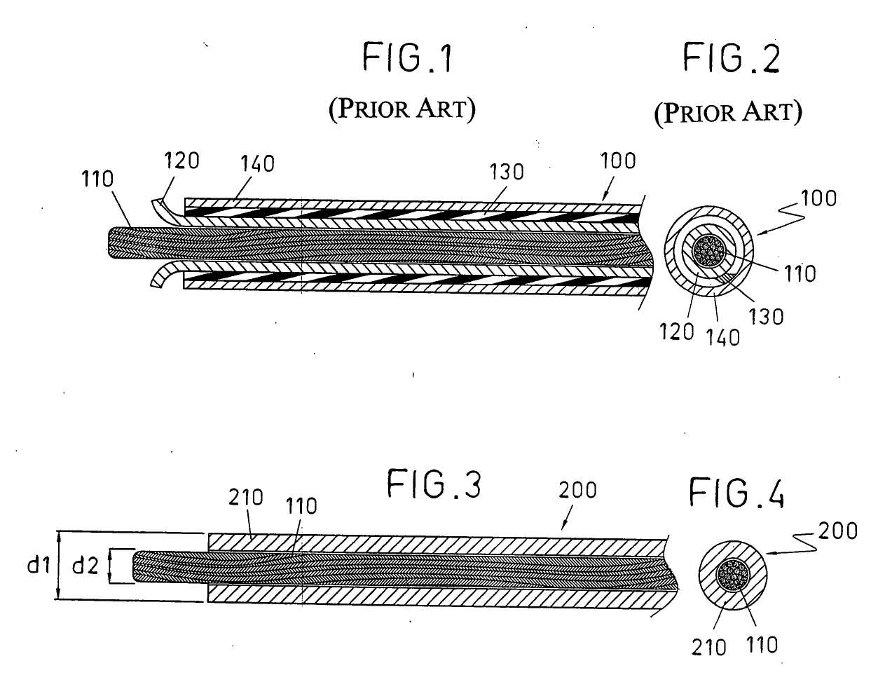

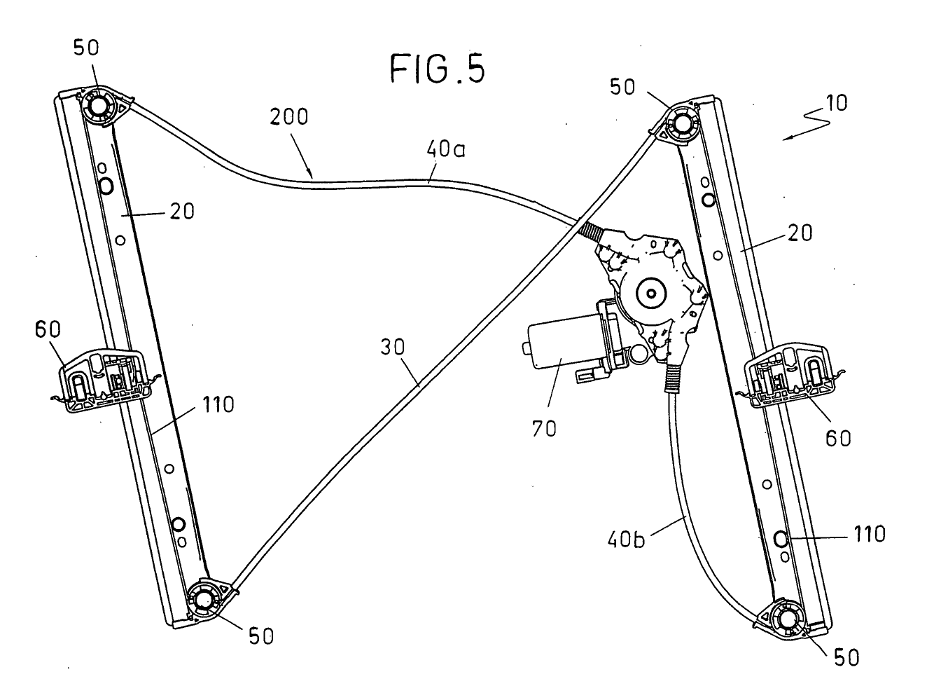

Referring to FIGS. 1 and 2, a conventional sheath (100) is used to cover a driving cable (110) in a power window device (10), FIG. 5, of a motor vehicle. The sheath (100) includes a coating structure surrounding the driving cable (110) of the power window device (10).

The coating structure of the sheath (100) is formed of a first inner layer (120) made of a semirigid material, an intermediate metal layer (130) including a metal coiled strip structure surrounding the first layer (120), and a third outer shielding plastic layer (140) surrounding the intermediate layer (130).

This three-layer configuration of the coating structure of the cable (110) is disadvantageous due to high costs and problems with noise, friction, oxidation, and the like.

Referring to FIGS. 3 and 4, the sheath (200) in accordance with an embodiment of the invention for the driving cable (110) in a power window device (10) of a motor vehicle has been considerably simplified with regard to the conventional sheaths, as shown in FIGS. 1 and 2. As best seen in FIGS. 3 and 4, the coating structure of the driving cable (110) is formed of a single outer layer (210) made of a semirigid plastic material with a low thermal expansion, such as polyacetal (POM).

The coating structure of the sheath (210) has an outer diameter (d1) ranging between 5 to 7 mm, preferably 6 mm, and an inner diameter (d2) ranging between 2.5 mm to 4 mm, and preferably 3 mm. These dimensions assure a proper assembly and operation of the power window assembly (10) with reduced costs.

As seen in FIG. 5, the power window device (10) of a motor vehicle includes two rails (20) along which the driving cable (110) slides. Device 10 can also be a single-rail power window device. The power window device (10) is also provided with pulleys (50) rotatably mounted on the rails (20) which cooperate to guide the driving cable (110). The driving cable (110) forces sliding members (60) to be moved upwards or downwards by an electric motor (70). The lower end of the window pane of the motor vehicle (not shown) is attached to the sliding members (60). The driving cable (110) is covered on certain lengths thereof by the sheath (200).

Alternatively, the sheath (200) may be provided on any of the three lengths (30, 40a, 40b) of the driving cable (110). It is preferred that the power window device (10) is provided with the sheath (200) of the invention at the very least on the rising length (40a) and on the lowering length (40b) of the driving cable (110), as they correspond to the operating lengths of the assembly. The lower length (30) may be provided with either a conventional sheath or it may be provided with the sheath (200).

While a particular embodiment has been chosen to illustrate the invention, it will be understood by those skilled in the art that various changes and modification can be made therein without departing from the scope of the invention as defined in the appended claims.

1. A coating sheath for a driving cable of a power window device for motor vehicles, comprising:
a coating structure enclosing the driving cable, coating structure being formed of a single layer of a semirigid plastic material with a low thermal expansion.

2. A coating sheath of claim 1, wherein
said coating structure has an outer diameter ranging between 5 to 7 mm.

3. A coating sheath of claim 1, wherein
said coating structure has an inner diameter ranging between 2.5 to 4 mm.

4. A coating sheath of claim 1, wherein
said coating structure has an outer diameter of 6 mm and an inner diameter (d2) of 3 mm.

5. A coating sheath of claim 1, wherein
the single layer of the coating structure consists of polyoxymethylene.
